(19) United States
(12) Patent Application Publication
(10) Pub. No.: US 2026/0047980 A1
(43) Pub. Date: Feb. 19, 2026

(54) CURVED-SURFACE DOUBLE-FUNNEL-SHAPED FLOW-GUIDING ELEMENT, SERIES-LINEAR FLOW-GUIDING ASSEMBLY, AND NESTED FLOW-GUIDING ASSEMBLY

(71) Applicant: HAOYU XING, SHENZHEN (CN)

(72) Inventors: HAOYU XING, SHENZHEN (CN); DONGQING YU, SHENZHEN (CN)

(21) Appl. No.: 19/370,940

(22) Filed: Oct. 28, 2025

Related U.S. Application Data
(63) Continuation of application No. PCT/CN2024/090408, filed on Apr. 28, 2024.

(30) Foreign Application Priority Data
Apr. 28, 2023 (WO) PCT/CN2023/091852
Sep. 26, 2023 (WO) PCT/CN2023/121357
Sep. 26, 2023 (WO) PCT/CN2023/121386

(51) Int. Cl. A61H 39/06

(52) U.S. Cl. CPC A61H 39/06; A61H 2201/0264

(57) ABSTRACT

Disclosed are a curved-surface double-funnel-shaped flow-guiding element, a series-linear flow-guiding assembly, and a nested flow-guiding assembly. Two openings are disposed at two ends of the curved-surface double-funnel-shaped flow-guiding element, and an interior of the curved-surface double-funnel-shaped flow-guiding element is hollow, to form a double-funnel-shaped flow channel. The curved-surface double-funnel-shaped flow-guiding element includes a first funnel and a second funnel, and cross-sectional lines of an inner wall of the first funnel and an inner wall of the second funnel along a central axis of the curved-surface double-funnel-shaped flow-guiding element are curved lines, and the curved lines are concave towards the central axis of the curved-surface double-funnel-shaped flow-guiding element.

### CROSS REFERENCE TO RELATED APPLICATIONS

The present disclosure is a continuation application of International (PCT) application No. PCT/CN2024/090408, filed on Apr. 28, 2024, which claims foreign priority to International application (PCT) No. PCT/CN2023/091852 filed on Apr. 28, 2023, further claims priority to International (PCT) application No. PCT/CN2023/121357 filed on Sep. 26, 2023, and also claims priority to International (PCT) application No. PCT/CN2023/121386 filed on Sep. 26, 2023, the disclosures of which are incorporated herein by reference in their entireties.

### TECHNICAL FIELD

The present disclosure relates to a curved-surface double-funnel-shaped flow-guiding element, a series-linear flow-guiding assembly, and a nested flow-guiding assembly.

### BACKGROUND

Many diseases in daily life are caused by the invasion and retention of cold in the human body. There are many methods in traditional Chinese medicine to dispel the cold, mainly including exercise therapy, internal treatment methods, and external treatment methods such as foot soaking, heat lamp treatment, moxibustion, massage, and gua sha.

The external treatment methods can rapidly increase the human body temperature by conducting and radiating heat energy, thereby achieving the effect of dispelling the cold. The external treatment methods in the traditional Chinese medicine include instrument-based physical therapy and manual physical therapy. The instrument-based physical therapy is convenient to operate in daily life, such as foot soaking, heat lamp treatment, etc., which can transfer heat into the human body without invasive operations, have high safety, few side effects, and certain therapeutic effects. However, since existing instruments only transfer heat into the human body to achieve the purpose of dispelling the cold, but do not guide the cold out of the human body, so that some of the cold will be driven out of the human body by the heat, but most of the cold will entangle with the heat and be trapped inside the human body, hindering the further discharge of the cold out of the human body. In terms of long-term effects, frequent use of such therapy products will cause the cold to be trapped deep inside the human body, making it more difficult to dispel.

The manual physical therapy can perform reinforcement and reduction through manipulation, conduct focused physical therapy according to individual differences, take effect quickly, and have relatively remarkable therapeutic effects. But it requires medical practitioners to have a certain level of medical skills, so that the manual physical therapy cannot be widely promoted, cannot be completed at home, and is inconvenient.

There is no other objective and easy-to-operate method that can dispel the cold from the human body now. An objective and easy-to-operate device that can dispel the cold from the human body and its using method are highly needed.

### SUMMARY

An objective of the present disclosure is to provide a curved-surface double-funnel-shaped flow-guiding element, a series-linear flow-guiding assembly, and a nested flow-guiding assembly applied to physical therapy equipment to improve the effect of dispelling cold.

The present disclosure discloses a curved-surface double-funnel-shaped flow-guiding element, two openings are disposed at two ends of the curved-surface double-funnel-shaped flow-guiding element, and an interior of the curved-surface double-funnel-shaped flow-guiding element is hollow, to form a double-funnel-shaped flow channel. The flow-guiding module is the curved-surface double-funnel-shaped flow-guiding element including a first funnel and a second funnel. The first funnel includes a large-mouth end and a small-mouth end, the second funnel includes a large-mouth end and a small-mouth end, a diameter of the large-mouth end of the first funnel is greater than a diameter of the small-mouth end of the first funnel, a diameter of the large-mouth end of the second funnel is greater than a diameter of the small-mouth end of the second funnel, and the small-mouth end of the first funnel is in fluid communication with the small-mouth end of the second funnel to form the double-funnel-shaped flow channel. Cross-sectional lines of an inner wall of the first funnel and an inner wall of the second funnel along a central axis of the curved-surface double-funnel-shaped flow-guiding element are curved lines, and the curved lines are concave towards the central axis of the curved-surface double-funnel-shaped flow-guiding element.

The present disclosure further discloses the series-linear flow-guiding assembly, two openings are disposed at two ends of the series-linear flow-guiding assembly, and an interior of the series-linear flow-guiding assembly is hollow, to form a flow channel. The series-linear flow-guiding assembly includes at least two curved-surface double-funnel-shaped flow-guiding elements being arranged in sequential orientation. The large-mouth ends of each pair of adjacent curved-surface double-funnel-shaped flow-guiding elements in the series-linear flow-guiding assembly are disposed opposite to each other. The projections of the large-mouth ends of each pair of adjacent curved-surface double-funnel-shaped flow-guiding elements at least partially overlap in the axial direction of the curved-surface double-funnel-shaped flow-guiding elements.

The present disclosure further discloses a nested flow-guiding assembly, two openings are disposed at two ends of the nested flow-guiding assembly, and an interior of the nested flow-guiding assembly is hollow, to form a flow channel. The nested flow-guiding assembly includes at least two levels of the curved-surface double-funnel-shaped flow-guiding elements. Sizes of the curved-surface double-funnel-shaped flow-guiding elements at different levels are different. The curved-surface double-funnel-shaped flow-guiding element at a lower level is nested within the curved-surface double-funnel-shaped flow-guiding element at a upper level. projections of the through-holes at a narrowest portion of the flow channels of the curved-surface double-funnel-shaped flow-guiding element at the upper level and the curved-surface double-funnel-shaped flow-guiding element at the lower level in the nested flow-guiding assembly at least partially overlap in the axial direction of the curved-surface double-funnel-shaped flow-guiding element at the upper level.

### BRIEF DESCRIPTION OF THE DRAWINGS

The included drawings are provided for further understanding of embodiments of the present disclosure, the drawings in the following description are merely some embodiments of the present disclosure. For those of ordinary skill in the art, other drawings may be obtained based on these drawings without creative labor. In the drawings:

FIG. 1 is a schematic diagram of a cold-dispelling equipment disclosed by the present disclosure.

FIG. 2 is a schematic diagram of a curved-surface double-funnel-shaped flow-guiding element according to the first embodiment of the present disclosure.

FIG. 3 is a schematic diagram of a surface change rule of an inner wall of the variable-curvature double-funnel-shaped flow-guiding element.

FIG. 4 is a schematic diagram of dimensions of the variable-curvature double-funnel-shaped flow-guiding element.

FIG. 5 is a schematic diagram of another variable-curvature double-funnel-shaped flow-guiding element according to the first embodiment of present disclosure.

FIG. 6 is a schematic diagram of another variable-curvature double-funnel-shaped flow-guiding element according to the first embodiment of present disclosure.

FIG. 7 is a schematic diagram of another variable-curvature double-funnel-shaped flow-guiding element according to the first embodiment of present disclosure.

FIG. 8 is a schematic diagram of the variable-curvature double-funnel-shaped flow-guiding element connected by a throat according to the first embodiment of present disclosure.

FIG. 9 is a schematic diagram of adding guiding meridians and guiding latitudes to the inner wall of the variable-curvature double-funnel-shaped flow-guiding element according to the first embodiment of the present disclosure.

FIG. 10 is a schematic diagram of a first wall-thickness change of the variable-curvature double-funnel-shaped flow-guiding element according to the first embodiment of the present disclosure.

FIG. 11 is a schematic diagram of a second wall-thickness change of the variable-curvature double-funnel-shaped flow-guiding element according to the first embodiment of the present disclosure.

FIG. 12 is a schematic diagram of a series-linear flow-guiding assembly according to the second embodiment of the present disclosure.

FIG. 13 is a schematic diagram of the distance arrangement between each pair of adjacent variable-curvature double-funnel-shaped flow-guiding elements according to the second embodiment of the present disclosure.

FIG. 14 is a schematic diagram of the variable-curvature double-funnel-shaped flow-guiding element in the series-linear flow-guiding assembly according to the second embodiment of the present disclosure.

FIG. 15 is a schematic diagram of the central axes of each pair of adjacent variable-curvature double-funnel-shaped flow-guiding elements not being on the same axis according to the second embodiment of the present disclosure.

FIG. 16 is a schematic diagram of each pair of adjacent variable-curvature double-funnel-shaped flow-guiding elements being in contact according to the second embodiment of the present disclosure.

FIG. 17 is a schematic diagram of the series-linear flow-guiding assembly being arranged in a sealed box according to the second embodiment of the present disclosure.

FIG. 18 is a schematic diagram of the series-linear flow-guiding assembly composed of three variable-curvature double-funnel-shaped flow-guiding elements according to the second embodiment of the present disclosure.

FIG. 19 is a schematic diagram of the specific design of the series-linear flow-guiding assembly according to the second embodiment of the present disclosure.

FIG. 20 is a schematic diagram of the series-linear flow-guiding assembly composed of five variable-curvature double-funnel-shaped flow-guiding elements according to the second embodiment of the present disclosure.

FIG. 21 is a schematic diagram of the series-linear flow-guiding assembly composed of five variable-curvature double-funnel-shaped flow-guiding elements and decreasing dimensions according to the second embodiment of the present disclosure.

FIG. 22 is a three-dimensional schematic diagram of the nested flow-guiding assembly according to the third embodiment of the present disclosure.

FIG. 23 is a side-view schematic diagram of the nested flow-guiding assembly according to the third embodiment of the present disclosure.

FIG. 24 is a schematic diagram of internal air passage of the nested flow-guiding assembly according to the third embodiment of the present disclosure.

FIG. 25 is an enlarged schematic diagram of area A of FIG. 24.

FIG. 26 is a schematic diagram of an internal distance of the nested flow-guiding assembly according to the third embodiment of the present disclosure.

FIG. 27 is a schematic diagram of another nested flow-guiding assembly according to the third embodiment of the present disclosure.

FIG. 28 is a schematic diagram of another nested flow-guiding assembly according to the third embodiment of the present disclosure.

FIG. 29 is a schematic diagram of the internal air passage of the nested flow-guiding assembly according to the third embodiment of the present disclosure.

FIG. 30 is a schematic diagram of the internal air passage of another nested flow-guiding assembly according to the third embodiment of the present disclosure.

FIG. 31 is an enlarged schematic diagram of area B of FIG. 30.

FIG. 32 is a schematic diagram of the internal distance of the nested flow-guiding assembly according to the third embodiment of the present disclosure.

FIG. 33 is a schematic diagram of the nested flow-guiding assembly according to the fourth implementation method of the third embodiment of the present disclosure.

FIG. 34 is a schematic diagram of a flow-guiding device according to the fourth embodiment of the present disclosure.

FIG. 35 is a schematic diagram of the flow-guiding device according to another implementation method of the fourth embodiment of the present disclosure.

FIG. 36 is a schematic diagram of another flow-guiding device according to the fourth embodiment of the present disclosure.

FIG. 37 is a schematic diagram of another flow-guiding device according to the fourth embodiment of the present disclosure.

FIG. 38 is a flowchart of a using method of a cold-dispelling equipment according to the fifth embodiment of the present disclosure.

FIG. 39 is a specific flowchart of the using method of the cold-dispelling equipment according to the fifth embodiment of the present disclosure.

FIG. 40 is a specific flowchart of another using method of the cold-dispelling equipment according to the fifth embodiment of the present disclosure.

### DETAILED DESCRIPTION

It should be understood that the terminology, specific structures, and functional details disclosed herein are merely configured to describe specific embodiments and are illustrative. However, the present disclosure may be implemented through many alternative forms and should not be construed as limited solely to the embodiments described herein.

In the description of the present disclosure, terms such as “first” and “second” are used solely for descriptive purposes and should not be interpreted as indicating relative importance or implicitly specifying the number of technical features indicated. Thus, unless otherwise specified, features qualified by “first” or “second” may explicitly or implicitly include one or more such features. “A plurality of” means two or more. Additionally, directional or positional terms such as “center,” “transversal,” “upper,” “lower,” “left,” “right,” “vertical,” “horizontal,” “top,” “bottom,” “inside,” or “outside” are described based on orientations or relative positional relationships shown in the accompanying drawings, which are used for simplified description to facilitate understanding of the present disclosure and do not imply that the devices or elements described should have specific orientations or be constructed or operated in specific orientations. These terms should not be construed as limiting the present disclosure. For those skilled in the art, the specific meaning of the above terms in the context of the present disclosure may be understood according to the specific situation.

The present disclosure is described in below in detail with reference to the accompanying drawings and optional embodiments.

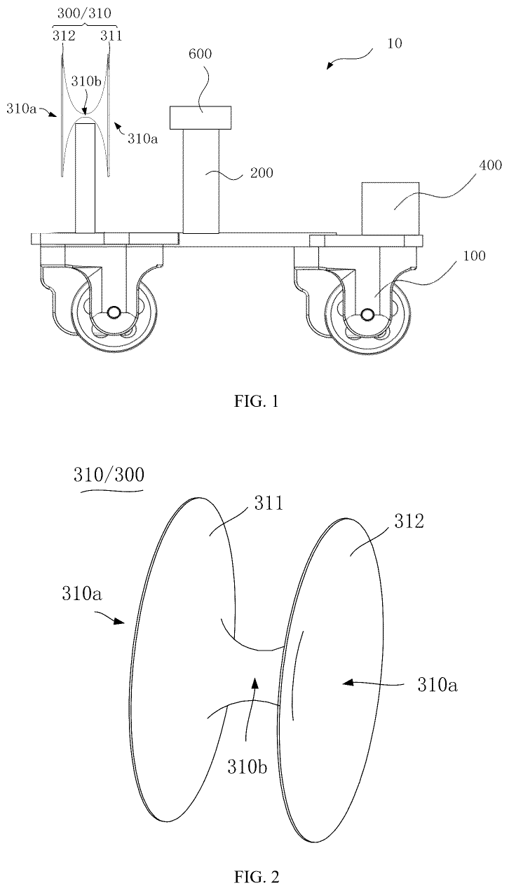

As shown in FIG. 1, the present disclosure discloses a cold-dispelling equipment 10. The cold-dispelling equipment 10 includes a moving component 100, an energy-source fixing structure 200, a flow-guiding module 300, and a control module 400. The energy-source fixing structure 200 is disposed on the moving component 100, and The energy-source fixing structure 200 is used to fix an energy source 600. The flow-guiding module 300 is disposed on the moving component 100. Two openings are disposed at two ends of the flow-guiding module 300, and an interior of the flow-guiding module 300 is hollow, to form a flow channel. A first end of the flow channel faces the energy source 600, and a second end of the flow channel faces the user to be dispelled of the cold. The control module 400 is connected to the moving component 100, and the control module 400 drives the moving component 100 to move the energy-source fixing structure 200 and the flow-guiding module 300 in a direction away from the user to be dispelled of the cold.

A first funnel 311 and a second funnel 312 are disposed axisymmetrical to each other. That is, a connection between the first funnel 311 and the second funnel 312 is the axis of symmetry, and the axis of symmetry is perpendicular to central axes of the first funnel 311 and the second funnel 312.

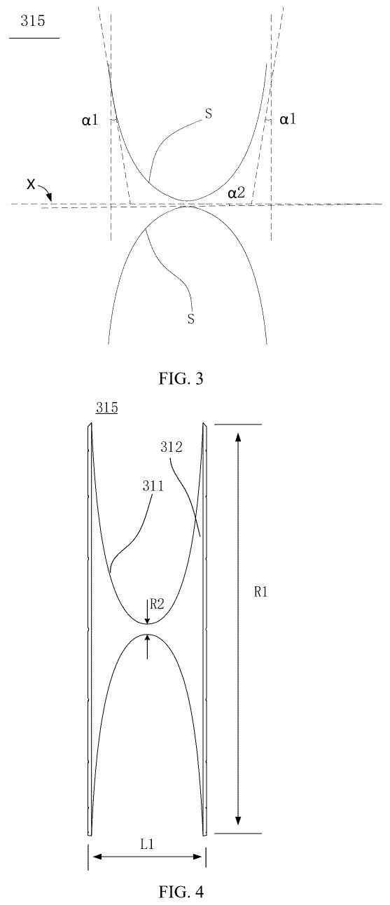

As shown in FIGS. 2 and 3, the embodiment of the present disclosure discloses the flow-guiding module 300 at least including the first funnel 311 and the second funnel 312, to form the flow channel. The first funnel 311 includes a large-mouth end 310a and a small-mouth end 310b, the second funnel 312 includes the large-mouth end 310a and the small-mouth end 310b. A diameter of the large-mouth end 310a of the first funnel 311 is greater than a diameter of the small-mouth end 310b of the first funnel 311, a diameter of the large-mouth end 310a of the second funnel 312 is greater than a diameter of the small-mouth end 310b of the second funnel 312. The large-mouth end 310a of the first funnel 311 faces the energy-source fixing structure 200, and the large-mouth end 310a of the second funnel 312 faces the user to be dispelled of the cold when using the flow-guiding module 300. Moreover, a gap between the large-mouth end 310a of the first funnel 311 and the energy source 600 should be left to better guide the cold.

As an implementation method, the flow-guiding module 300 has an axially symmetric structure with the extending direction of the flow channel as the central axis X. Cross-sectional lines of an inner wall of the first funnel 311 and an inner wall of the second funnel 312 along the central axis of the flow-guiding module 300 are curved lines, and the curved lines are concave towards the central axis of the flow-guiding module 300. The inner wall of the first funnel 311 and the inner wall of the second funnel 312 adopt concave curved-shaped surfaces.

The cross-sectional lines of the inner wall of the first funnel 311 and the inner wall of the second funnel 312 of the flow-guiding module 300 along the central axis of the flow-guiding module 300 are the curved lines. The curved lines S are concave towards the central axis of the flow-guiding module 300. Curvatures of the curved lines of the first funnel 311 and the second funnel 312 gradually increase or first increases to a maximum value and then decreases from the large-mouth ends 310a of the first funnel 311 and the second funnel 312 to the small-mouth ends 310b of the first funnel 311 and the second funnel 312.

It should be noted that the cold-dispelling equipment 10 disclosed in the embodiment of the present disclosure may not be equipped with the energy source 600. The energy source 600 can be sold separately. The energy source 600 is added and installed on the energy-source fixing structure 200 when using the cold-dispelling equipment 10. In the embodiment of the present disclosure, the energy source 600 may adopt a substance rich in yang energy, such as moxa sticks and other moxa products, essential oils 620, or infrared/LED light sources, either individually or in combination.

The moving component 100 may move on a certain plane or track, which may be achieved through wheels, ropes, tracks, sliders, etc, and can drive the energy-source fixing structure 200 and the flow-guiding module 300 to move under the control of the control module 400.

The following takes various flow-guiding modules as specific embodiments for further explanation.

### Embodiment 1: Curved-Surface Double-Funnel-Shaped Flow-Guiding Element

FIG. 2 illustrates the flow-guiding module according to the first embodiment of the present disclosure. As shown in FIG. 2, the flow-guiding module 300 is the curved-surface double-funnel-shaped flow-guiding element 310. The flow channel of the curved-surface double-funnel-shaped flow-guiding element 310 is double-funnel shaped. The curved-surface double-funnel-shaped flow-guiding element 310 includes the first funnel 311 and the second funnel 312. The first funnel 311 includes a large-mouth end 310a and a small-mouth end 310b, and the second funnel 312 includes the large-mouth end 310a and the small-mouth end 310b. A diameter of the large-mouth end 310a of the first funnel 311 is greater than a diameter of the small-mouth end 310b of the first funnel 311, and a diameter of the large-mouth end 310a of the second funnel 312 is greater than a diameter of the small-mouth end 310b of the second funnel 312. The small-mouth end 310b of the first funnel 311 is in fluid communication with the small-mouth end 310b of the second funnel 312 to form the double-funnel-shaped flow channel.

As an implementation method of the curved-surface double-funnel-shaped flow-guiding element, as shown in FIG. 3, the curved-surface double-funnel-shaped flow-guiding element is a variable-curvature double-funnel-shaped flow-guiding element 315. The cross-sectional lines of the inner wall of the flow channel along the central axis of the variable-curvature double-funnel-shaped flow-guiding element 315 are the curved lines S, the curved lines S extend towards the large-mouth end 310a of the variable-curvature double-funnel-shaped flow-guiding element 315, and its curvature approaches zero. Tangent lines corresponding to endpoints of the curved line of the large-mouth ends 310a of the first funnel 311 are perpendicular or approximately perpendicular to the central axis of the variable-curvature double-funnel-shaped flow-guiding element 315, and tangent lines corresponding to endpoints of the curved line of the large-mouth end 310a of the second funnel 312 are perpendicular or approximately perpendicular to the central axis of the variable-curvature double-funnel-shaped flow-guiding element 315. In other words, angles α1 formed between the tangent lines corresponding to endpoints of the curved line S of the large-mouth ends 310a of the first funnel 311 and the second funnel 312 and perpendicular lines of the central axis of the variable-curvature double-funnel-shaped flow-guiding element 315 may approach or be close to 0 degrees. That is, the large-mouth end 310a of the first funnel 311 or the second funnel 312 approaches a plane perpendicular to the central axis of the variable-curvature double-funnel-shaped flow-guiding element 315.

Tangent lines corresponding to endpoints of the curved line S of the small-mouth end 310b of the first funnel 311 or the second funnel 312 are parallel to the central axis of the variable-curvature double-funnel-shaped flow-guiding element 315. In other words, angles α2 formed between the tangent lines corresponding to endpoints of the curved line S of the small-mouth end 310b of the first funnel 311 or the second funnel 312 and the central axis of the variable-curvature double-funnel-shaped flow-guiding element 315 approach 0 degrees. The cross-sectional line of the inner wall of the second funnel 312 is the same as that of the inner wall of the first funnel 311, and will not be elaborated here.

Understandably, the aims of the embodiment of the present disclosure are that the tangent lines of the large-mouth ends 310a of the first funnel 311 and the second funnel 312 are approximately perpendicular to the central axis of the variable-curvature double-funnel-shaped flow-guiding element 315. Diameters of the small-mouth ends 310b of the first funnel 311 and the second funnel 312 approach infinitely small. However, as long as curvature change trend of the curved lines of the first funnel 311 and the second funnel 312 satisfies the rule of increasing from the large-mouth ends 310a of the first funnel 311 and the second funnel 312 to the small-mouth ends 310b of the first funnel 311 and the second funnel 312, that is, the curved lines of the first funnel 311 and the second funnel 312 are closer to the small-mouth ends of the first funnel 311 and the second funnel 312, the curvature value would be greater and the curvature of the curved lines would be more drastic, it should fall inside the protection scope of the present application.

Referring to FIG. 4, examples of size ranges of three types of the variable-curvature double-funnel-shaped flow-guiding elements 315, namely, large-sized, medium-sized, and small-sized, are given here.

Large-sized: a diameter R1 of the large-mouth ends 310a of the first funnel 311 and the large-mouth end 310a of the second funnel 312 ranges from 200 mm to 400 mm, a diameter R2 of the small-mouth ends 310b of the first funnel 311 and the second funnel 312 ranges from 20 mm to 40 mm, and a distance L1, measured along the central axis, between the large-mouth end 310a of the first funnel 311 and the large-mouth end 310a of the second funnel 312 ranges from 100 mm to 220 mm.

Medium-sized: the diameter R1 ranges from 100 mm to 200 mm, the diameter R2 ranges from 10 mm to 20 mm, and the distance L1 ranges from 50 mm to 110 mm.

Small-sized: the diameter R1 ranges from 10 mm to 100 mm, the diameter R2 ranges from 1 mm to 10 mm, and the distance L1 ranges from 5 mm to 50 mm.

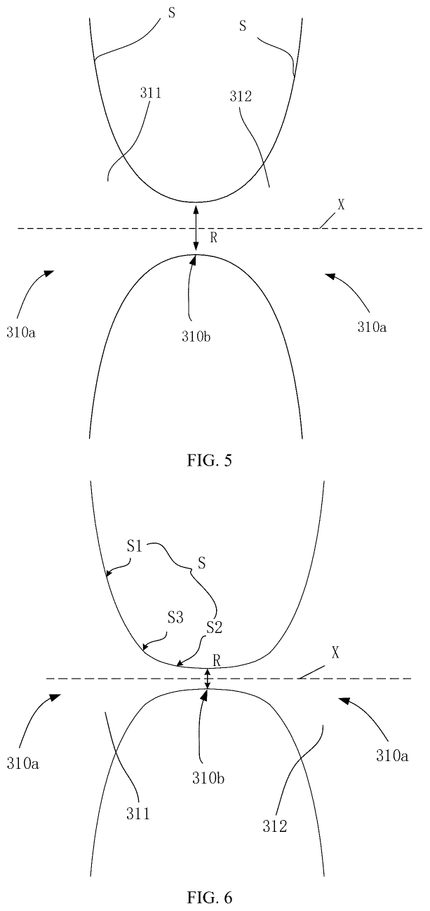

As shown in FIG. 5, different from the previous embodiment, the cross-sectional lines of the first funnel 311 and the second funnel 312 along the central axis X of the variable-curvature double-funnel-shaped flow-guiding element 315 are the curved lines. The tangent lines corresponding to endpoints of the curved lines of the large-mouth ends 310a of the first funnel 311 and the second funnel 312 are approximately perpendicular to the central axis X of the variable-curvature double-funnel-shaped flow-guiding element 315.

Further, the curved lines S approach being parallel to the central axis X of the variable-curvature double-funnel-shaped flow-guiding element 315 toward directions of the small-mouth ends 310b of the first funnel 311 and second funnel 312, and the curvatures of the curved lines S approach zero. The diameters of the small-mouth ends 310b of the first funnel 311 and second funnel 312 approach a preset diameter R, where the preset diameter R is not equal to zero, and a recommended range of the preset diameter R is 1 mm to 40 mm.

As another implementation method, as shown in FIG. 6, the cross-sectional lines of the inner wall of the first funnel 311 and the inner wall of the second funnel 312 along the central axis of the variable-curvature double-funnel-shaped flow-guiding element 315 are the curved lines S. The curvatures of the curved lines S of the first funnel 311 and the second funnel 312 first increases to a maximum value and then decreases from the large-mouth ends 310a of the first funnel 311 and the second funnel 312 to the small-mouth ends 310b of the first funnel 311 and the second funnel 312, that is, a curvature of the curved segment S3 is the largest, and is greater than the curvatures of the curved segments S1 and S2.

The curved lines S of the first funnel 311 and the second funnel 312 of the variable-curvature double-funnel-shaped flow-guiding element 315 corresponding to end portion of the large-mouth ends 310a of the first funnel 311 and the second funnel 312 are approximately perpendicular to the central axis X of the variable-curvature double-funnel-shaped flow-guiding element 315. The curved lines S may not be perpendicular to the central axis X of the variable-curvature double-funnel-shaped flow-guiding element 315 and may have a certain angle (such as the curved lines form a 60° acute Angle with the central axis of of the variable-curvature double-funnel-shaped flow-guiding element 315 when it is directed towards an inner portion of the of the variable-curvature double-funnel-shaped flow-guiding element 315), but the effect may not be as good as that when the curved lines S are approximately perpendicular to the central axis X of the variable-curvature double-funnel-shaped flow-guiding element 315.

Each of the curved lines include a first curved segment S1, a second curved segment S2, and a third curved segment S3. A head end of the first curved segment S1 corresponds to the large-mouth end 310a of the variable-curvature double-funnel-shaped flow-guiding element 315. A tail end of the second curved segment S2 corresponds to the small-mouth end 310b of the variable-curvature double-funnel-shaped flow-guiding element 315. The tail end of the first curved segment S1 and the head end of the second curved segment S2 are connected to two ends of the third curved segment S3 respectively. A curvature of the first curved segment S1 gradually increases from the head end of the first curved segment S1 to the tail end of the first curved segment S1. A curvature of the second curved segment S2 decreases gradually from the head end of the second curved segment S2 to the tail end of the second curved segment S2, and the tail end of the second curved segment S2 approaches the central axis of the variable-curvature double-funnel-shaped flow-guiding element 315, that is, the diameter R at the narrowest portion of the middle portion of each of the curved line S of the variable-curvature double-funnel-shaped flow-guiding element 315 approaches 0. Moreover, a curvature of the third curved segment S3 is greater than the curvatures at the tail end of the first curved segment S1 and the curvature at the head end of the second curved segment S2.

Alternatively, it can be understood as follows: each of the curved line includes two portions, the first curved segment S1 and the second curved segment S2. The tail end of the first curved segment S1 is connected to the head end of the second curved segment S2. The curvature of the first curved segment S1 gradually increases from the head end of the first curved segment S1 to the tail end of the first curved segment S1, the curvature of the second curved segment S2 decreases gradually from the head end of the second curved segment S2 to the tail end of the second curved segment S2, which further improves guiding effect of the flow-guiding module and enhances the stability of the flow-guiding module when the cold establishes a connection with the energy source.

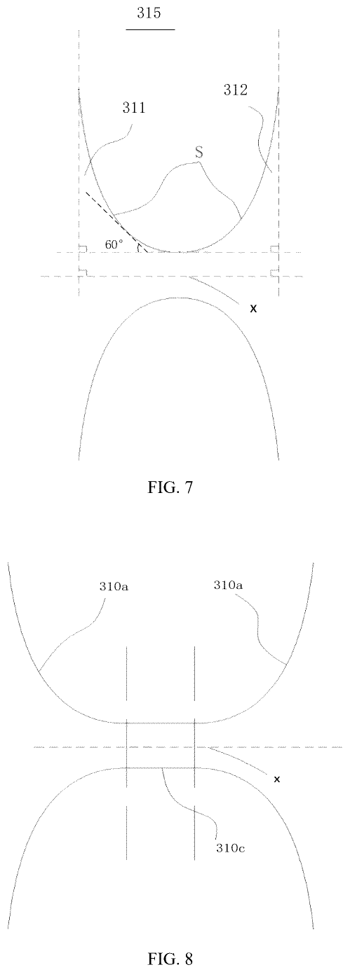

As shown in FIG. 7, in another implementation method, the tangent lines corresponding to the curved line of the large-mouth ends 310a of the first funnel 311 and the second funnel 312 of the variable-curvature double-funnel-shaped flow-guiding element 315 are perpendicular to the central axis of variable-curvature double-funnel-shaped flow-guiding element 315.

The tangent lines of the small-mouth end 310b corresponding to the curved line are parallel to the central axis X of the variable-curvature double-funnel-shaped flow-guiding element 315. The diameter of the small-mouth end 310b may be flexibly set as needed, such as ranging from 1 mm to 40 mm. A connection between the small-mouth end 310b of the first funnel 311 and the small-mouth end 310b of the second funnel 312 has a smooth transition. The angle between the tangent line at any point on the curved lines and the central axis gradually decreases from 90° to 0° from the direction of the large-mouth end 310a to the small-mouth end 310b. The diameter of the flow channel at the small-mouth end 310b is smaller than the diameter of the flow channel at any other point of the variable-curvature double-funnel-shaped flow-guiding element 315.

In the embodiment of the present application, the small-mouth end 310b of the first funnel 311 is directly in fluid communication with the small-mouth end 310b of the second funnel 312, and the connection between the small-mouth end of the first funnel and the small-mouth end of the second funnel has a smooth transition without abrupt changes or sharp angles. Alternatively, as shown in FIG. 8, the curved-surface double-funnel-shaped flow-guiding element 310 or even the variable-curvature double-funnel-shaped flow-guiding element 315 further includes a throat 310c. The interior of the throat 310c is hollow, two openings are disposed at two ends of the throat 310c, and the throat 310c is in a cylindrical shape. Two ends of the throat 310c are respectively in fluid communication with the small-mouth end 310b of the first funnel 311 and the small-mouth end 310b of the second funnel 312. A connection between the small-mouth end 310b of the first funnel 311 and the throat 310c has a smooth transition. A connection between the small-mouth end 310b of the second funnel 312 and the throat 310c has a smooth transition.

The throat 310c may be cylindrical, with a cross-section being a straight line parallel to the central axis X of the curved-surface double-funnel-shaped flow-guiding element 310, allowing cold to transition from the first funnel 311 to the second funnel 312 along the direction parallel to the central axis of the curved-surface double-funnel-shaped flow-guiding element 310, thus achieving a better cold guiding effect. Moreover, the throat 310c in a shape of cylindrical facilitates fixtures to fix the curved-surface double-funnel-shaped flow-guiding element 310 from the middle. Since interiors of the first funnel 311 and the second funnel 312 are concave curved surfaces, a length of the throat 310c should be shortened as much as possible, guiding process of the cold from the first funnel 311 through the throat 310c to the second funnel 312 will be smoother, thereby improving the cold guiding effect.

The throat 310c may also adopt a concave curved surface without doubt, and the curvature variation rule of the curved surface is different from that of the first funnel 311 and the second funnel 312.

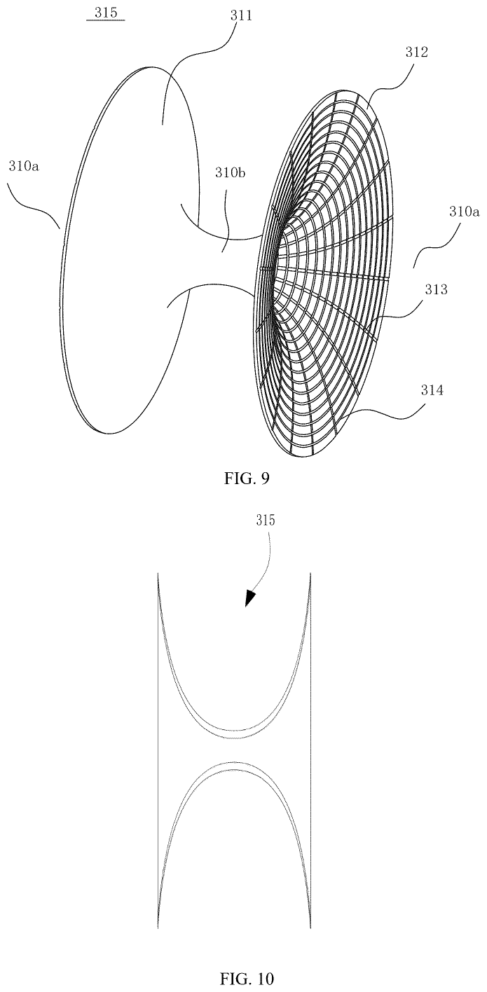

As shown in FIG. 9, the inner wall of the curved-surface double-funnel-shaped flow-guiding element 310 (the variable-curvature double-funnel-shaped flow-guiding element 315) is provided with a plurality of guiding meridians 313 or guiding latitudes 314. Each of the plurality of the guiding meridians 313 are arranged to extend from the large-mouth end 310a of the first funnel 311 to the large-mouth end 310a of the second funnel 312. A distance between each pair of adjacent guiding meridians 313 is equal on a same vertical plane of the central axis of the variable-curvature double-funnel-shaped flow-guiding element 315. The distance between each pair of adjacent the guiding meridians 313 gradually increases along an extending direction from a center of the variable-curvature double-funnel-shaped flow-guiding element 315 to two ends thereof. Each of the plurality of the guiding latitudes 314 surrounds the central axis of the flow channel, and the plurality of the guiding latitudes are arranged at intervals along the direction of the central axis of the flow channel. Concentric circular guiding latitudes 314 are added on the inner wall of the variable-curvature double-funnel-shaped flow-guiding element 315, with their diameters decreasing from the large-mouth ends 310a to the small-mouth ends 310b of the first funnel and the second funnel.

The distance between each pair of adjacent guiding latitudes 314 gradually increases along an extending direction from the center of the variable-curvature double-funnel-shaped flow-guiding element 315 to the two ends thereof.

It can be understood that the guiding latitudes 314 and guiding meridians 313 can be used alone or in combination, and can be used alone or in combination on the curved-surface double-funnel-shaped flow-guiding element 310. And the guiding meridians 313 and guiding latitudes 314 are respectively formed by creating grooves on the inner wall of the curved-surface double-funnel-shaped flow-guiding element 310.

In an embodiment where the guiding latitudes 314 and guiding meridians 313 are used in combination, the distance between each pair of adjacent guiding meridians 313 is equal on the same vertical plane of the central axis of the variable-curvature double-funnel-shaped flow-guiding element 315, The guiding latitudes 314 and the guiding meridians 313 are arranged in a staggered manner.

As shown in FIG. 10, an outer wall of the variable-curvature double-funnel-shaped flow-guiding element 315 is recessed toward the direction close to the central axis. The thickness of the wall of the variable-curvature double-funnel-shaped flow-guiding element 315 gradually increases from the two ends to the center.

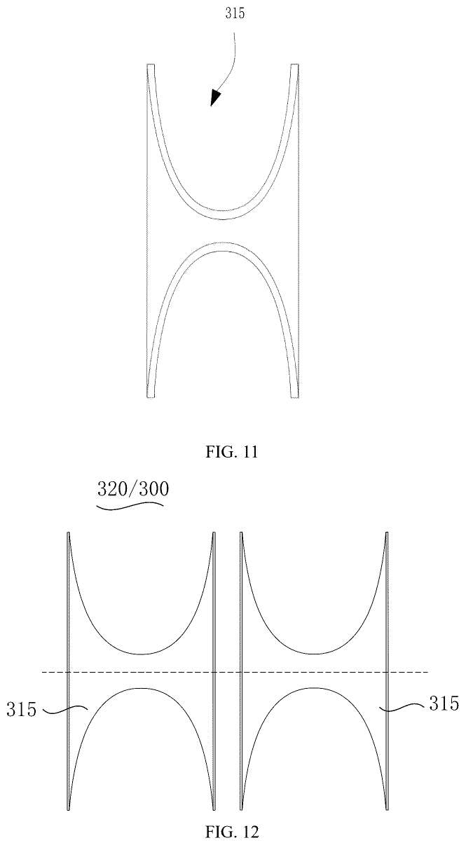

As shown in FIG. 11, the variable-curvature double-funnel-shaped flow-guiding element 315 may also be formed as a shell with a uniform thickness. Specifically, an outer wall of the variable-curvature double-funnel-shaped flow-guiding element 315 is recessed toward the direction close to the central axis, and the thickness of the wall of the variable-curvature double-funnel-shaped flow-guiding element 315 is the same at any position. The thickness of the wall of the variable-curvature double-funnel-shaped flow-guiding element 315 is uniform and consistent both internally and externally, enhancing the cold guiding capability. It can be understood that, on the premise that the variable-curvature double-funnel-shaped flow-guiding element 315 meets the strength requirements, the difference in the thickness of the wall of the variable-curvature double-funnel-shaped flow-guiding element 315 smaller, to get better cold guiding capability. And overall thickness of the wall of the variable-curvature double-funnel-shaped flow-guiding element 315 thinner, to get better cold guiding capability.

The curved-surface double-funnel-shaped flow-guiding element 310 disclosed in the embodiment may be made of transparent materials. And the transparent material may be transparent plastic.

### Embodiment 2: Series-Linear Flow-Guiding Assembly

The flow-guiding module provided in the second embodiment of the present application is a series-linear flow-guiding assembly 320. Two openings are disposed at two ends of the series-linear flow-guiding assembly 320, and an interior of the series-linear flow-guiding assembly 320 is hollow, to form a flow channel. The series-linear flow-guiding assembly 320 includes at least two curved-surface double-funnel-shaped flow-guiding elements being arranged in sequential orientation. In this embodiment, the variable-curvature double-funnel-shaped flow-guiding element 315 is taken as an example for illustration. Projections of the large-mouth ends 310a of each pair of adjacent variable-curvature double-funnel-shaped flow-guiding elements 315 at least partially overlap in an axial direction of each pair of variable-curvature double-funnel-shaped flow-guiding elements 315.

Where the structure of the variable-curvature double-funnel-shaped flow-guiding element 315 refers to the description in the first embodiment, and will not be elaborated here.

It should be understood that each of the variable-curvature double-funnel-shaped flow-guiding elements 315 is a completely separate and independent structure, and will not be nested together. It can also be understood that, orthographic projection of each of the variable-curvature double-funnel-shaped flow-guiding elements 315 does not overlap with each other in the direction perpendicular to the central axis of the variable-curvature double-funnel-shaped flow-guiding elements 315,

For the convenience of explanation and understanding, the embodiment of the present application takes the series-linear flow-guiding assembly 320 composed of the two variable-curvature double-funnel-shaped flow-guiding elements 315 as an example for detailed description.

As shown in FIG. 12, as an implementation method in the embodiment of the present application, the central axes of each pair of the variable-curvature double-funnel-shaped flow-guiding elements 315 are aligned on the same straight line.

When the central axes of the variable-curvature double-funnel-shaped flow-guiding elements 315 in the series-linear flow-guiding assembly 320 are located on the same straight line, regardless of whether the dimensions of the variable-curvature double-funnel-shaped flow-guiding elements 315 are the same or not, the cold converges in the same linear direction in the series-linear flow-guiding assembly 320 under the attraction of the energy source 600, thereby further improving the convergence effect of the cold and reducing the degree of attenuation of the connection between the energy source 600 and the cold.

In this implementation method, the two double-funnel-shaped variable-curvature double-funnel-shaped flow-guiding elements 315 have the same shape and equal size.

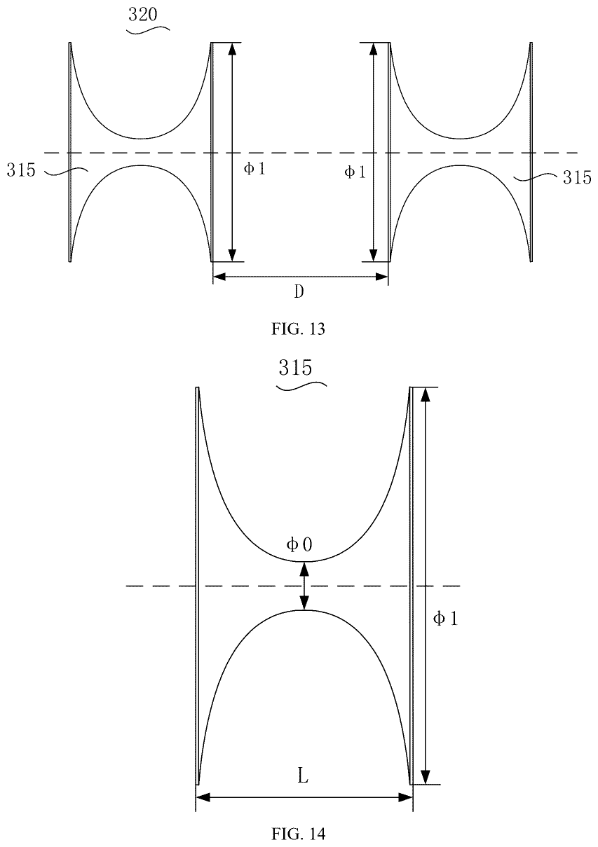

As shown in FIG. 13 and FIG. 14, a distance is formed between each pair of adjacent variable-curvature double-funnel-shaped flow-guiding elements 315, which is served as D. The diameter of each of the large-mouth ends 310a of the variable-curvature double-funnel-shaped flow-guiding elements 315 is served as φ1. The diameter of the throat is served as φ0, and the length of each of the variable-curvature double-funnel-shaped flow-guiding elements 315 is served as L.

Optionally, D is greater than or equal to 0.1φ1 and less than or equal to 1.5φ1. Further, D is greater than or equal to 0.3φ1 and less than or equal to 0.8φ1. specifically, D is equal to 0.5φ1.

And φ0:φ1:L equal 1:7-13:2-8.

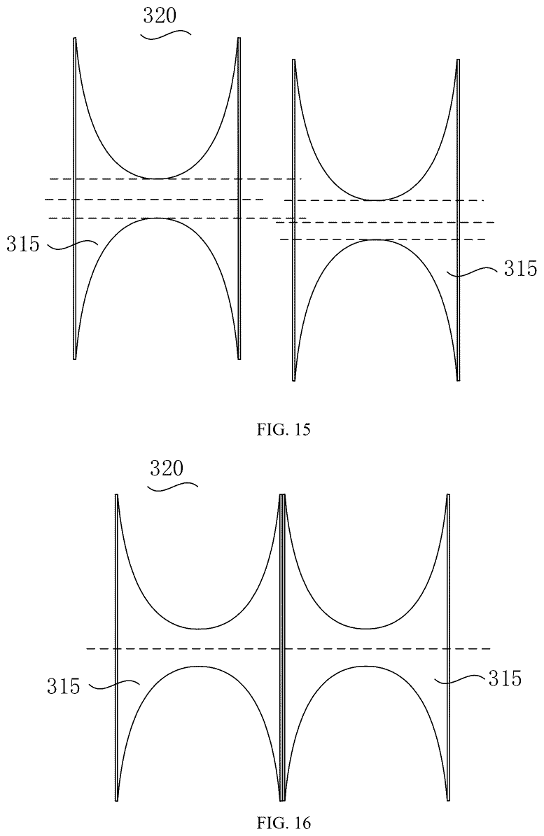

As shown in FIG. 15, as the second implementation method of the embodiment of the present application, the central axes of the two variable-curvature double-funnel-shaped flow-guiding elements 315 in this implementation method may not be on the same axes. However, projections of each pair of the variable-curvature double-funnel-shaped flow-guiding elements 315 at the throat at least partially overlap in the axial direction of each pair of the double-funnel-shaped flow-guiding elements 315.

As shown in FIG. 16, as the third implementation method of the embodiment of the present application, The central axes of all the variable-curvature double-funnel-shaped flow-guiding elements 315 in the series-linear flow-guiding assembly 320 of this implementation method are on the same straight line. And the large-mouth ends 310a of each pair of adjacent variable-curvature double-funnel-shaped flow-guiding elements 315 are in fluid communication with each other.

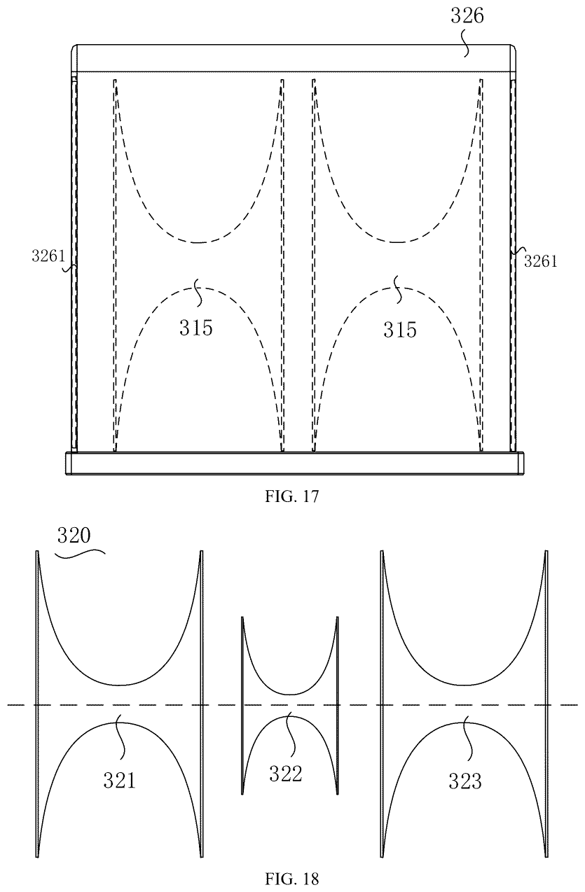

Further, as shown in FIG. 17, in the above implementation methods, a sealing box 326 may also be added to the series-linear flow-guiding assembly 320, and all the variable-curvature double-funnel-shaped flow-guiding elements 315 are fixed inside the sealing box 326. Moreover, hollowed-out portions 3261 are provided at the front and rear ends of the sealing box corresponding to positions of the two ends of the series-linear flow-guiding assembly 320, and the hollowed-out portions 3261 are formed by arranging a plurality of through holes in an array.

In addition, in the embodiment of the present application, the number of the variable-curvature double-funnel-shaped flow-guiding elements 315 in the series-linear flow-guiding assembly 320 is not limited to two, may also be three, four, five, or even more. Since the number of the variable-curvature double-funnel-shaped flow-guiding elements 315 connected in series within the series-linear flow-guiding assembly 320 is greater, the connection between the cold and the energy source 600 is more stable.

As the fourth implementation method of the embodiment of the present application, at least two variable-curvature double-funnel-shaped flow-guiding elements 315 in the series-linear flow-guiding assembly 320 have different sizes. That is, the series-linear flow-guiding assembly 320 includes the at least two variable-curvature double-funnel-shaped flow-guiding elements 315 with different sizes. The series-linear flow-guiding assembly 320 includes at least three variable-curvature double-funnel-shaped flow-guiding elements 315. The two variable-curvature double-funnel-shaped flow-guiding elements 315 at two ends of the series-linear flow-guiding assembly 320 have the same size, which is greater than or equal to the size of the variable-curvature double-funnel-shaped flow-guiding element 315 between the two ends of the series-linear flow-guiding assembly 320. Moreover, the large-mouth ends 310a of each pair of adjacent variable-curvature double-funnel-shaped flow-guiding elements 315 in the series-linear flow-guiding assembly 320 are disposed opposite to each other. The projections of the large-mouth ends of each pair of adjacent variable-curvature double-funnel-shaped flow-guiding elements 315 at least partially overlap in an axial direction of each pair of adjacent variable-curvature double-funnel-shaped flow-guiding elements 315.

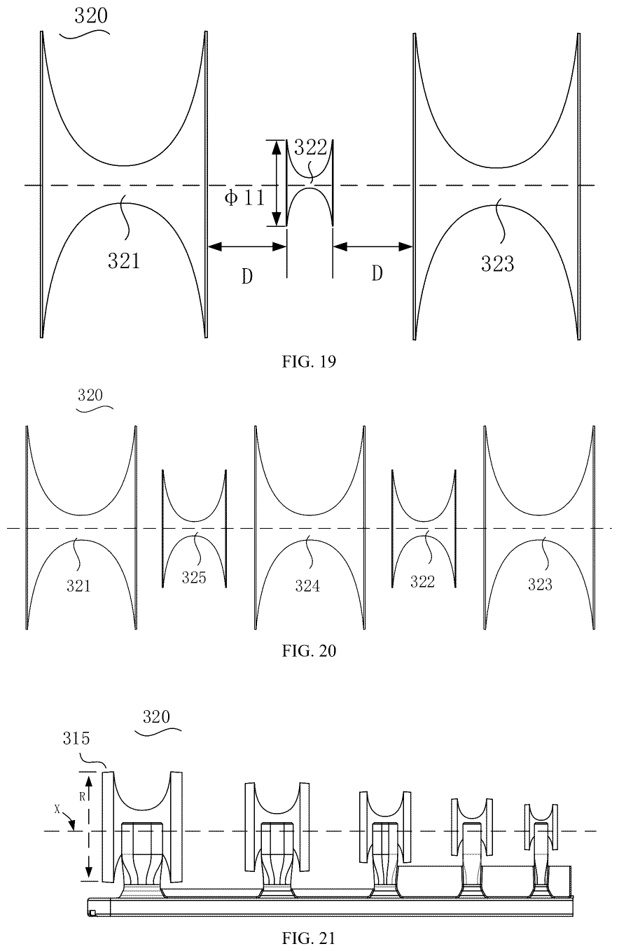

As shown in FIG. 18, for the convenience of explanation and understanding, this implementation method takes the series-linear flow-guiding assembly 320 including the three variable-curvature double-funnel-shaped flow-guiding elements 315 as an example, where the three double-funnel-shaped flow-guiding elements 315 adopt two different sizes for detailed description.

Specifically, the number of the variable-curvature double-funnel-shaped flow-guiding elements 315 in the series-linear flow-guiding assembly 320 is three. The three double-funnel-shaped flow-guiding elements 315 are respectively a first variable-curvature double-funnel-shaped flow-guiding element 321, a second variable-curvature double-funnel-shaped flow-guiding element 322, and a third variable-curvature double-funnel-shaped flow-guiding element 323. The second variable-curvature double-funnel-shaped flow-guiding element 322 is disposed between the first variable-curvature double-funnel-shaped flow-guiding element 321 and the third variable-curvature double-funnel-shaped flow-guiding element 323. And a size of the first variable-curvature double-funnel-shaped flow-guiding element 321 is equal to that of the third variable-curvature double-funnel-shaped flow-guiding element 323, and both are larger than the size of the second variable-curvature double-funnel-shaped flow-guiding element 322.

Further, as shown in FIG. 19, a size ratio between larger sizes of the first variable-curvature double-funnel-shaped flow-guiding element 321 and the third variable-curvature double-funnel-shaped flow-guiding element 323 to smaller size of the second variable-curvature double-funnel-shaped flow-guiding element 322 is between 2-8:1, and further, the size ratio of 5:1 may be chosen.

A distance between the larger element 321/323 and its adjacent smaller element 322 is defined as D. The diameter of the large-mouth end 310a of the smaller element 322 is defined as φ11. The relationship between D and φ11 satisfies: 0.8φ11≤D≤2.5φ11.

As the fifth implementation method in the embodiment of the present application, as shown in FIG. 20, the series-linear flow-guiding assembly 320 includes five variable-curvature double-funnel-shaped flow-guiding elements 315 connected in series within the series-linear flow-guiding assembly 320. Specifically, the series-linear flow-guiding assembly 320 is composed of the first variable-curvature double-funnel-shaped flow-guiding element 321, the second variable-curvature double-funnel-shaped flow-guiding element 322, the third variable-curvature double-funnel-shaped flow-guiding element 323, a fourth variable-curvature double-funnel-shaped flow-guiding element 324, and a variable-curvature double-funnel-shaped flow-guiding element 325. Where sizes of the first variable-curvature double-funnel-shaped flow-guiding element 321, the third variable-curvature double-funnel-shaped flow-guiding element 323, and the fourth variable-curvature double-funnel-shaped flow-guiding element 324 are the same. And sizes of the second variable-curvature double-funnel-shaped flow-guiding element 322 and the fifth variable-curvature double-funnel-shaped flow-guiding element 325 are the same.

Moreover, the fifth variable-curvature double-funnel-shaped flow-guiding element 325 is disposed between the first variable-curvature double-funnel-shaped flow-guiding element 321 and the fourth variable-curvature double-funnel-shaped flow-guiding element 324. The second variable-curvature double-funnel-shaped flow-guiding element 322 is disposed between the fourth variable-curvature double-funnel-shaped flow-guiding element 324 and the third variable-curvature double-funnel-shaped flow-guiding element 323. That is, in the series-linear flow-guiding assembly 320, the first variable-curvature double-funnel-shaped flow-guiding element 321, the fifth variable-curvature double-funnel-shaped flow-guiding element 325, the fourth variable-curvature double-funnel-shaped flow-guiding element 324, the second variable-curvature double-funnel-shaped flow-guiding element 322, and the third variable-curvature double-funnel-shaped flow-guiding element 323 are connected in series in sequence.

As the fifth implementation method in the embodiment of the present application, as shown in FIG. 21, the series-linear flow-guiding assembly 320 includes five variable-curvature double-funnel-shaped flow-guiding elements 315 connected in series within the series-linear flow-guiding assembly 320. Specifically, the five variable-curvature double-funnel-shaped flow-guiding elements 315 have the same shape but different sizes. The diameter R of the large-mouth end of each of the five variable-curvature double-funnel-shaped flow-guiding elements 315 decreases one by one along the direction of the central axes X of the five variable-curvature double-funnel-shaped flow-guiding elements 315 from left to right. It should be noted that the number of the variable-curvature double-funnel-shaped flow-guiding elements 315 is not limited to five, and any number of three or more is within the protection scope of the present application.

### Embodiment 3: Nested Flow-Guiding Assembly

As the flow-guiding module 300 provided in the third embodiment of the present application, the flow-guiding module 300 is a nested flow-guiding assembly 330. Two openings are disposed at two ends of the nested flow-guiding assembly 330, and an interior of the nested flow-guiding assembly 330 is hollow, to form a flow channel. The nested flow-guiding assembly 330 includes at least two levels of the variable-curvature double-funnel-shaped flow-guiding elements 315, sizes of the variable-curvature double-funnel-shaped flow-guiding elements 315 at different levels are different, and the variable-curvature double-funnel-shaped flow-guiding element 315 at a lower level is nested within the variable-curvature double-funnel-shaped flow-guiding element 315 at a upper level. The flow channel of the nested flow guide assembly 330 is a flow channel inside the variable-curvature double-funnel-shaped flow-guiding element 315 with the smallest size.

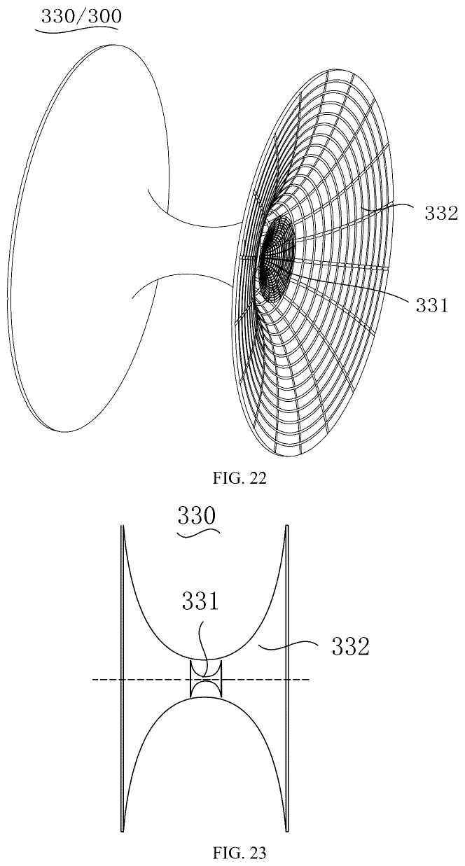

As shown in FIG. 22, as the first implementation method in the embodiment of the present application, the nested flow-guiding assembly 330 is a two-level single-nested flow-guiding assembly 330 including two levels of the variable-curvature double-funnel-shaped flow-guiding elements, and each level of the variable-curvature double-funnel-shaped flow-guiding elements has only one.

Specifically, the nested flow-guiding assembly 330 in the embodiment of the present application is formed by nesting a first variable-curvature double-funnel-shaped flow-guiding element 331 and a second variable-curvature double-funnel-shaped flow-guiding element 332. The size of the first variable-curvature double-funnel-shaped flow-guiding element 331 is smaller than that of the second variable-curvature double-funnel-shaped flow-guiding element 332, and the first variable-curvature double-funnel-shaped flow-guiding element 331 is nested within the second variable-curvature double-funnel-shaped flow-guiding element 332.

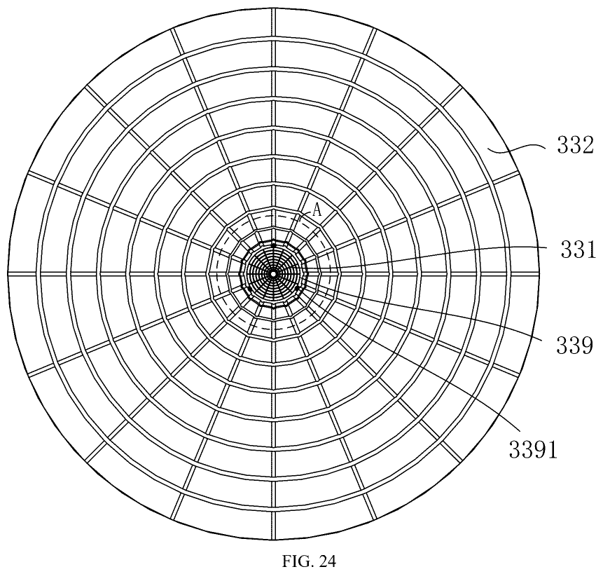

As shown in FIG. 23, in this implementation method, a central axis of the first variable-curvature double-funnel-shaped flow-guiding element 331 coincides with that of the second variable-curvature double-funnel-shaped flow-guiding element 332.

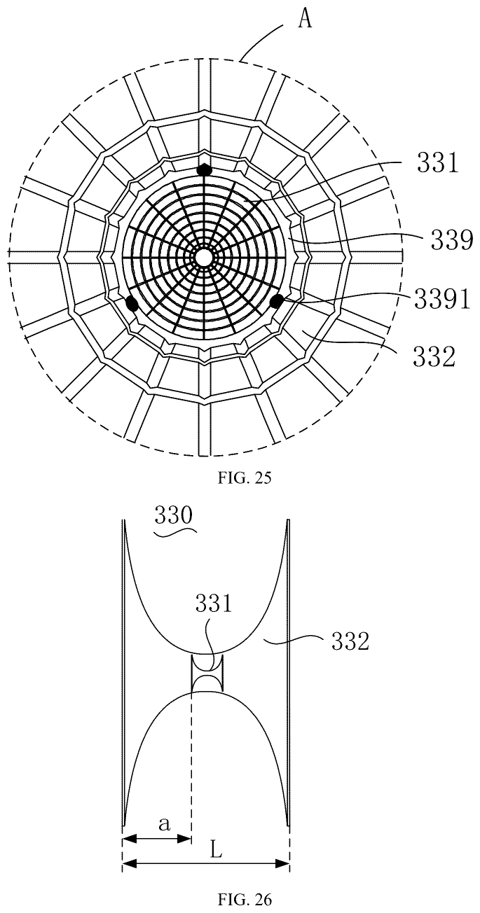

As shown in FIGS. 24 and 25, an air passage 339 is provided between the first variable-curvature double-funnel-shaped flow-guiding element 331 and the second variable-curvature double-funnel-shaped flow-guiding element 332. Two ends of the air passage 339 are respectively in communication with the external environment at two ends of the nested flow-guiding assembly 330, allowing gas to pass through between an outer side of the first variable-curvature double-funnel-shaped flow-guiding element 331 and an inner side of the second variable-curvature double-funnel-shaped flow-guiding element 332.

Optionally, edges of the large-mouth ends 310a at the two ends of the first variable-curvature double-funnel-shaped flow-guiding element 331 are fixed to the inner wall of the second variable-curvature double-funnel-shaped flow-guiding element 332 via three glue dispensing points 3391. A angle between each pair of adjacent glue dispensing points 3391 is 120°, which ensures the stability between the first variable-curvature double-funnel-shaped flow-guiding element 331 and the second variable-curvature double-funnel-shaped flow-guiding element 332 while avoiding an area of the air passage 339 from decreasing and affecting the cold guiding capability of the second variable-curvature double-funnel-shaped flow-guiding element 332.

In addition, as shown in FIG. 26, a distance “a” between the large-mouth end 310a of the second variable-curvature double-funnel-shaped flow-guiding element 332 and the corresponding large-mouth end 310a of the first variable-curvature double-funnel-shaped flow-guiding element 331 exceeds one-fourth of a length “L” of the second variable-curvature double-funnel-shaped flow-guiding element 332.

Further, the distance, measured along the central axis, between the large-mouth end 310a of the first variable-curvature double-funnel-shaped flow-guiding element 331 and the corresponding large-mouth end 310a of the variable-curvature double-funnel-shaped flow-guiding element 332 may also exceed one-third of an axial length of the second variable-curvature double-funnel-shaped flow-guiding element 332.

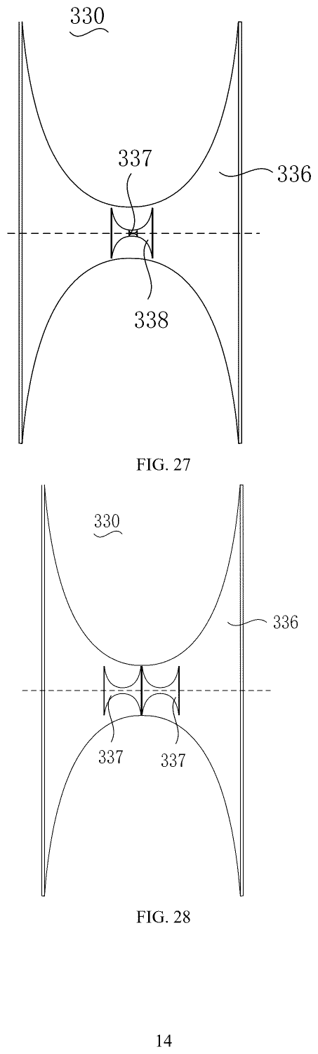

As shown in FIG. 27, as the second implementation method in the embodiment of the present application, the difference from the first implementation method is that this implementation method adopts the nested flow-guiding assembly with three-level nesting, which is a three-level single-nested flow-guiding assembly. Specifically, the nested flow-guiding assembly 330 includes a first-level variable-curvature double-funnel-shaped flow-guiding element 336, a second-level variable-curvature double-funnel-shaped flow-guiding element 337, and a third-level variable-curvature double-funnel-shaped flow-guiding element 338. The third-level variable-curvature double-funnel-shaped flow-guiding element 338 is nested within the second-level variable-curvature double-funnel-shaped flow-guiding element 337, and the second-level variable-curvature double-funnel-shaped flow-guiding element 337 is nested within the first-level variable-curvature double-funnel-shaped flow-guiding element 336. Moreover, projections of through-holes of the first-level variable-curvature double-funnel-shaped flow-guiding element 336, the second-level variable-curvature double-funnel-shaped flow-guiding element 337, and the third-level variable-curvature double-funnel-shaped flow-guiding element 338 overlap at the narrowest portion of the flow channel in the axial direction of the first-level variable-curvature double-funnel-shaped flow-guiding element 336.

Meanwhile, in this implementation method, the distance, measured along the central axis, between the large-mouth end of the third-level variable-curvature double-funnel-shaped flow-guiding element 338 and the corresponding large-mouth end of the second-level variable-curvature double-funnel-shaped flow-guiding element 337 exceeds one-third of the axial length of the second-level variable-curvature double-funnel-shaped flow-guiding element 337. The distance, measured along the central axis, between the large-mouth end of the second-level variable-curvature double-funnel-shaped flow-guiding element 337 and the corresponding large-mouth end of the first-level variable-curvature double-funnel-shaped flow-guiding element 336 exceeds one-third of the axial length of the first-level variable-curvature double-funnel-shaped flow-guiding element 336.

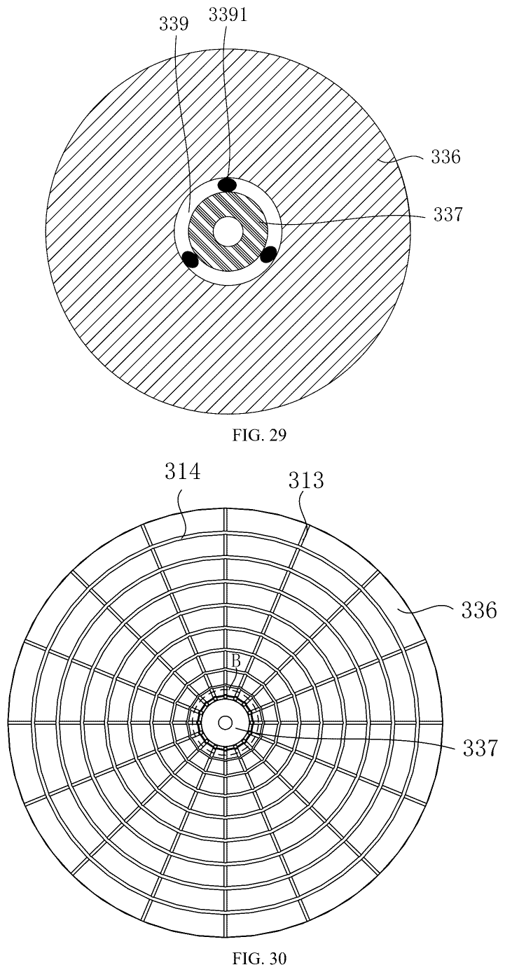

As shown in FIG. 28, as the third implementation method in the embodiment of the present application, the difference from the above-mentioned implementation method is that in this implementation method, the number of the variable-curvature double-funnel-shaped flow-guiding element 315 at a lower level is two. Specifically, the nested flow-guiding assembly 330 adopts a two-level double-nested flow-guiding assembly, including the first-level variable-curvature double-funnel-shaped flow-guiding element 336 and second-level variable-curvature double-funnel-shaped flow-guiding element 337. The number of the first-level variable-curvature double-funnel-shaped flow-guiding element 336 is one, and the number of the second-level variable-curvature double-funnel-shaped flow-guiding element 337 is two. Two second-level variable-curvature double-funnel-shaped flow-guiding elements 337 are nested side by side within the first-level variable-curvature double-funnel-shaped flow-guiding element 336, with no gap between the two second-level variable-curvature double-funnel-shaped flow-guiding elements 337. The projections of the through-holes of each pair of the second-level variable-curvature double-funnel-shaped flow-guiding elements 337 and the first-level variable-curvature double-funnel-shaped flow-guiding element 336 overlap at the narrowest portion of the flow channel.

As a way to form the air passage 339, as shown in FIG. 29, an area of the large-mouth end 310a of the second-level variable-curvature double-funnel-shaped flow-guiding element 337 is smaller than an area of the first-level variable-curvature double-funnel-shaped flow-guiding element 336 at the minimum throat 310c, that is, a size of the through-hole at the narrowest portion of the flow channel. Fitting portion of the two second-level variable-curvature double-funnel-shaped flow-guiding elements 337 are fixed within the first-level variable-curvature double-funnel-shaped flow-guiding element 336 by means of glue dispensing.

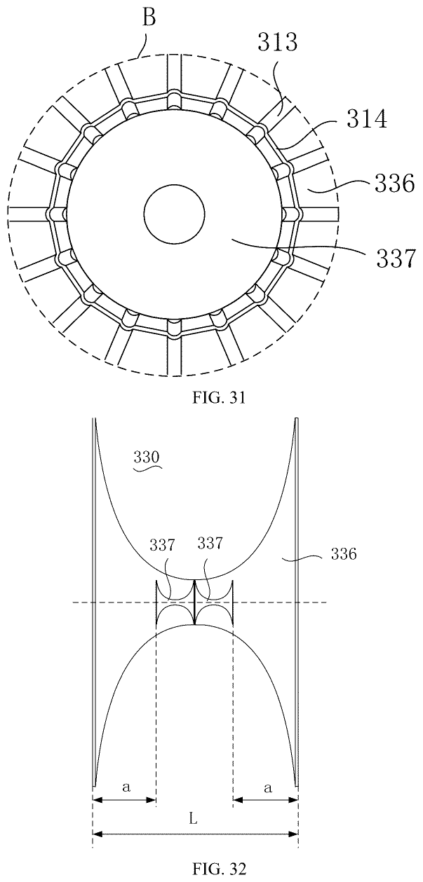

As another way to form the air passage 339, as shown in FIGS. 30 and 31, the plurality of the guiding meridians 313 and the plurality of the guiding latitudes 314 are arranged on the inner wall of the first-level variable-curvature double-funnel-shaped flow-guiding element 336. The plurality of the guiding meridians 313 extend from one end opening of the flow channel to the other end opening of the flow channel, and the plurality of the guiding latitudes 314 surround the central axis of the flow channel and are arranged at intervals along the direction of the central axis of the flow channel. Moreover, the guiding meridians 313 and the guiding latitudes 314 are groove structures, forming the air passage 339.

In addition, as shown in FIG. 32, the distance “a” between outer ends of the two second-level variable-curvature double-funnel-shaped flow-guiding elements 337 (i.e., the large-mouth ends of the two second-level variable-curvature double-funnel-shaped flow-guiding elements 337 far from center point of the first-level variable-curvature double-funnel-shaped flow-guiding element 336) and the corresponding large-mouth end of the first-level variable-curvature double-funnel-shaped flow-guiding element 336 exceeds one-fourth of the length “L” of the first-level variable-curvature double-funnel-shaped flow-guiding element 336.

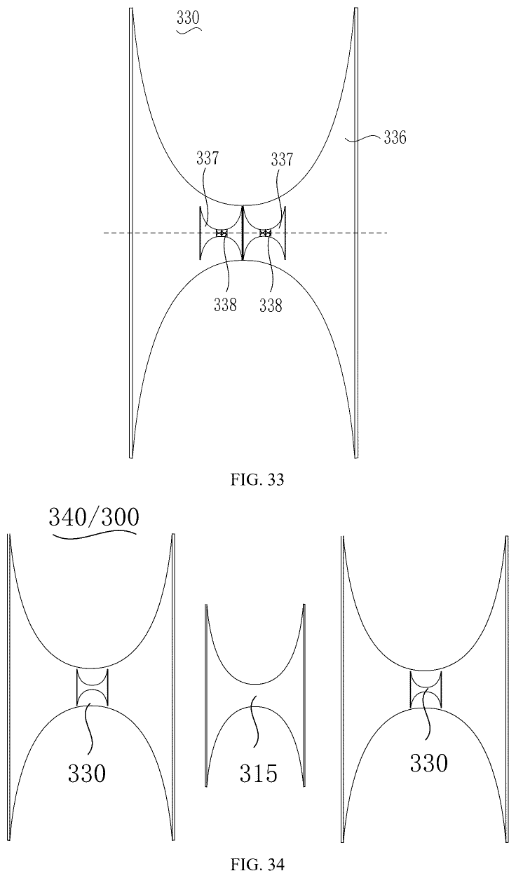

As shown in FIG. 33, as the fourth implementation method provided in the embodiment of the present application, the difference from the third implementation method is that the nested flow-guiding assembly 330 in this implementation method adopts a three-level nesting method, which is a three-level double-nested flow-guiding assembly. Specifically, the nested flow-guiding assembly 330 includes a first-level variable-curvature double-funnel-shaped flow-guiding element 336, second-level variable-curvature double-funnel-shaped flow-guiding element 337, and third-level variable-curvature double-funnel-shaped flow-guiding element 338. The number of the first-level variable-curvature double-funnel-shaped flow-guiding element 336 is one, the number of the second-level variable-curvature double-funnel-shaped flow-guiding element 337 is two, and the number of the third-level variable-curvature double-funnel-shaped flow-guiding element 338 is four. The two third-level variable-curvature double-funnel-shaped flow-guiding elements 338 are nested side-by-side within one second-level variable-curvature double-funnel-shaped flow-guiding element 337, and the two second-level variable-curvature double-funnel-shaped flow-guiding elements 337 are nested side-by-side within the first-level variable-curvature double-funnel-shaped flow-guiding element 336.

Similarly, in this implementation method, the variable-curvature double-funnel-shaped flow-guiding element 315 at the same level have the same size and shape.

Consistent with the previous implementation method, in the nested flow-guiding assembly 330, the central axes of all the variable-curvature double-funnel-shaped flow-guiding elements 315 coincide. The third-level variable-curvature double-funnel-shaped flow-guiding element 338 is a scaled-down version of the second-level variable-curvature double-funnel-shaped flow-guiding element 337 in equal proportion, and the second-level variable-curvature double-funnel-shaped flow-guiding element 337 is a scaled-down version of the first-level variable-curvature double-funnel-shaped flow-guiding element 336 in equal proportion.

In the first-level variable-curvature double-funnel-shaped flow-guiding element 336, the fitting portion between the two second-level variable-curvature double-funnel-shaped flow-guiding elements 337 is located at the center point of the first-level variable-curvature double-funnel-shaped flow-guiding element 336, i.e., the narrowest portion of the throat 310c of the first-level variable-curvature double-funnel-shaped flow-guiding element 336. However, the two second-level variable-curvature double-funnel-shaped flow-guiding elements 337 do not block the flow channel of the first-level variable-curvature double-funnel-shaped flow-guiding element 336, leaving the air passage 339 between the first-level variable-curvature double-funnel-shaped flow-guiding element 336 and the second-level variable-curvature double-funnel-shaped flow-guiding elements 337. Similarly, in the second-level variable-curvature double-funnel-shaped flow-guiding element 337, the fitting portion between the two third-level variable-curvature double-funnel-shaped flow-guiding elements 338 is located at the center point of the corresponding second-level variable-curvature double-funnel-shaped flow-guiding element 337, i.e., the narrowest portion of the throat 310c of the second-level variable-curvature double-funnel-shaped flow-guiding element 337. The two third-level variable-curvature double-funnel-shaped flow-guiding elements 315 also do not block the flow channel of the corresponding second-level variable-curvature double-funnel-shaped flow-guiding element 337, leaving the air passage 339 between the second-level variable-curvature double-funnel-shaped flow-guiding element 337 and the corresponding third-level variable-curvature double-funnel-shaped flow-guiding element 338.

For the design of the air passage 339, please refer to the description in the third implementation method for details, and no further elaboration will be made here.

In this implementation method, in each second-level variable-curvature double-funnel-shaped flow-guiding element 337, the distance between the outer ends of the two third-level variable-curvature double-funnel-shaped flow-guiding elements 338 (i.e., the large-mouth ends 310a far from the center point of the second-level variable-curvature double-funnel-shaped flow-guiding element 337) and the corresponding large-mouth end 310a of the second-level variable-curvature double-funnel-shaped flow-guiding element 337 exceeds one-fourth of the length of the second-level variable-curvature double-funnel-shaped flow-guiding element 337. Similarly, the distance between the outer ends of the two second-level variable-curvature double-funnel-shaped flow-guiding elements 337 (i.e., the large-mouth ends 310a far from the center point of the first-level variable-curvature double-funnel-shaped flow-guiding element 336) and the corresponding large-mouth end 310a of the first-level variable-curvature double-funnel-shaped flow-guiding element 336 exceeds one-fourth of the length of the first-level variable-curvature double-funnel-shaped flow-guiding element 336.

Furthermore, the distance between the outer end of the third-level variable-curvature double-funnel-shaped flow-guiding element 338 and the corresponding large-mouth end 310a of the second-level variable-curvature double-funnel-shaped flow-guiding element 337 may be adjusted as needed to exceed one-third of the length of the second-level variable-curvature double-funnel-shaped flow-guiding element 337. The distance between the outer ends of the second-level variable-curvature double-funnel-shaped flow-guiding element 337 and the corresponding large-mouth end 310a of the first-level variable-curvature double-funnel-shaped flow-guiding element 336 may exceed one-third of the length of the first-level variable-curvature double-funnel-shaped flow-guiding element 336.

It should be noted that, in the embodiment of the present application, the nested flow-guiding assembly 330 may also adopt a design with more than four levels, that is, the nested flow-guiding assembly 330 is formed by nesting more than four levels of the variable-curvature double-funnel-shaped flow-guiding elements 315, and each upper-level variable-curvature double-funnel-shaped flow-guiding element 315 may be nested with more than three lower-level variable-curvature double-funnel-shaped flow-guiding elements 315 inside. The specific selection is based on actual needs, and the specific design refers to the specific design of the overall of the nested flow-guiding assembly 330 and each pair of two-level variable-curvature double-funnel-shaped flow-guiding elements 315 in the embodiment of the present application, which will not be elaborated here.

### Embodiment 4: Flow-Guiding Device

As the flow-guiding module 300 provided in the fourth embodiment of the present application, the flow-guiding module 300 is a flow-guiding device 340, which includes at least one nested flow-guiding assembly 330 as disclosed in the embodiment 3.

As shown in FIG. 34, as the first implementation method in the embodiment of the present application, the flow-guiding device 340 is composed of two nested flow-guiding assemblies 330 and an independent variable-curvature double-funnel-shaped flow-guiding element 315. And the variable-curvature double-funnel-shaped flow-guiding element 315 is located between the two nested flow-guiding assemblies 330.

Further, the size of the variable-curvature double-funnel-shaped flow-guiding element 315 is smaller than that of the outermost variable-curvature double-funnel-shaped flow-guiding element 315 in the two nested flow-guiding assemblies 330.

In this implementation method, the central axes of the two nested flow-guiding assemblies 330 and the variable-curvature double-funnel-shaped flow-guiding element 315 coincide. The two nested flow-guiding assemblies 330 have the same size and shape. The variable-curvature double-funnel-shaped flow-guiding element 315 located between the two nested flow-guiding assemblies 330 is a scaled-down version in equal proportion of the outermost variable-curvature double-funnel-shaped flow-guiding element 315 in the nested flow-guiding assemblies 330. Moreover, the distance between the variable-curvature double-funnel-shaped flow-guiding element 315 and each of the nested flow-guiding assemblies 330 is equal.

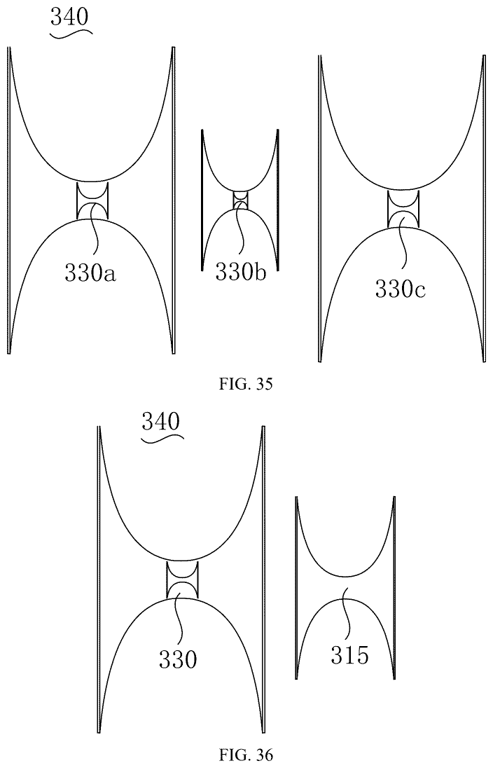

As shown in FIG. 35, as the second implementation method in the embodiment of the present application, the flow-guiding device 340 is composed of three nested flow-guiding assemblies 330, namely a first nested flow-guiding assembly 330a, a second nested flow-guiding assembly 330b, and a third nested flow-guiding assembly 330c. Where the second nested flow-guiding assembly 330b is located between the first nested flow-guiding assembly 330a and the third nested flow-guiding assembly 330c. The first nested flow-guiding assembly 330a and the third nested flow-guiding assembly 330c have the same size, and a size of the second nested flow-guiding assembly 330b is smaller than that of the first nested flow-guiding assembly 330a.

In this implementation method, the central axes of the three nested flow-guiding assemblies 330 coincide, and a distance between the second nested flow-guiding assembly 330b and the first nested flow-guiding assembly 330a is equal to a distance between the second nested flow-guiding assembly 330b and the third nested flow-guiding assembly 330c.

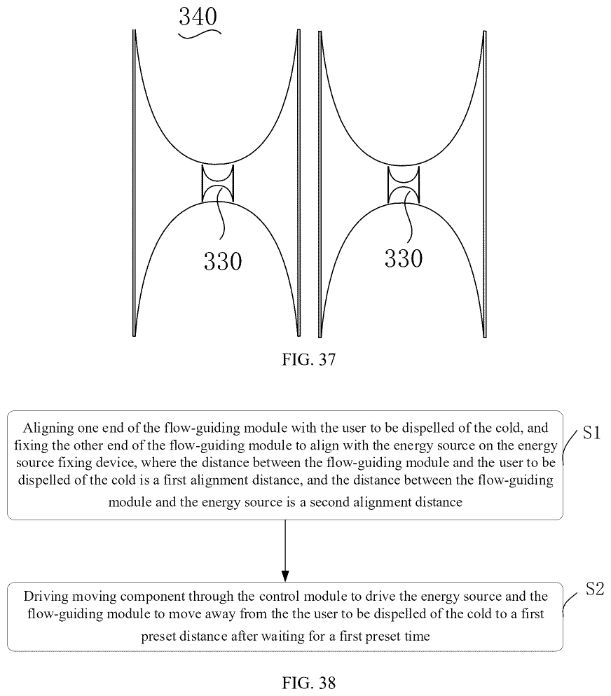

It should be noted that, as shown in FIGS. 36 and 37, the flow-guiding device 340 may also be composed of only one independent variable-curvature double-funnel-shaped flow-guiding element 315 and one nested flow-guiding assembly 330, or only two nested flow-guiding assemblies 330 of the same size.

### Embodiment 5

As shown in FIG. 38, the present application also provides a using method of a cold-dispelling equipment, which is applied to the above-mentioned cold-dispelling equipment. The using method includes the following steps:

S1: aligning one end of the flow-guiding module with the user to be dispelled of the cold, and fixing the other end of the flow-guiding module to align with the energy source on the energy source fixing device, where the distance between the flow-guiding module and the user to be dispelled of the cold is a first alignment distance, and the distance between the flow-guiding module and the energy source is a second alignment distance.

S2: driving the moving component through the control module to drive the energy source and the flow-guiding module to move away from the user to be dispelled of the cold to a first preset distance after waiting for a first preset time.

In step S1, the two ends of the flow channel in the flow-guiding module are respectively aligned with the user to be dispelled of the cold and the energy source. The first alignment distance is from 5 cm to 30 cm, and the second alignment distance is from 5 cm to 30 cm. Of course, the alignment distance can be adjusted accordingly based on actual conditions.

In step S2, the first preset time is from 10 seconds to 300 seconds (to avoid excessive waiting, it may be further limited to a range of 10 seconds to 60 seconds), and the first preset distance is from 50 cm to 200 cm. Moreover, the energy source and the flow-guiding module move at a consistent and uniform speed when the moving component drives the energy source and the flow-guiding module to move to the first preset distance in the direction away from the user to be dispelled of the cold, and the moving speed is between 2 mm/s and 5 mm/s.

After step S2, the energy source and the flow-guiding module stay for a second preset time (e.g., the second preset time may be from 10 seconds to 300 seconds, to avoid excessive waiting, the second preset time may be further limited to a range of 10 seconds to 60 seconds).

Of course, keeping the energy source stationary and moving away the flow-guiding module is also feasible, and the connection between the cold and the energy source would not be interrupted in this case.

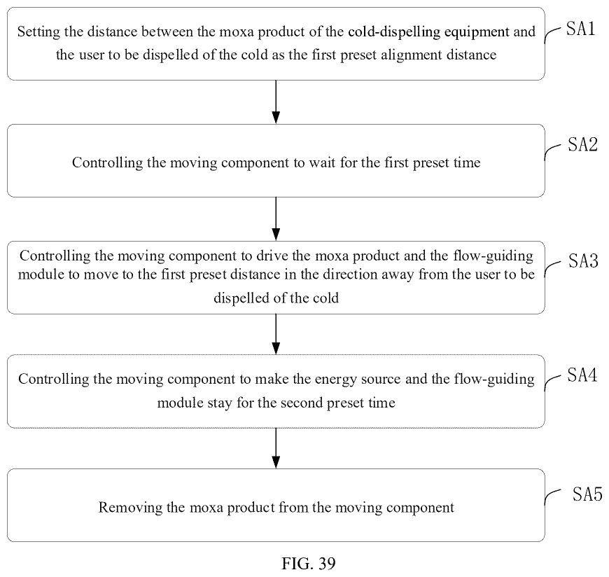

When the energy source is an moxa product, as shown in FIG. 39, the using method of the cold-dispelling equipment, includes the following steps:
SA1: setting the distance between the moxa product of the cold-dispelling equipment and the user to be dispelled of the cold as the first preset alignment distance;
SA2: controlling the moving component to wait for the first preset time;
SA3: controlling the moving component to drive the moxa product and the flow-guiding module to move to the first preset distance in the direction away from the user to be dispelled of the cold;
SA4: controlling the moving component to make the energy source and the flow-guiding module stay for the second preset time;
SA5: removing the moxa product from the moving component.

Where in step SA2, the first preset time is from 10 seconds to 30 seconds. In step SA3, the first preset distance is from 70 cm to 120 cm. In step SA4, the second preset time is from 10 seconds to 20 seconds. Of course, keeping the energy source stationary and moving away the flow-guiding module is also feasible, and the connection between the cold and the energy source would not be interrupted in this case.

It should be noted that the moxa product remains ignited when the device is started, that is, the moxa product is ignited before step SA1, the ignited moxa product is removed in step SA5, and the user to be dispelled of the cold is directly contact with the burning moxa product after step SA5. Entire physiotherapy process ends when the moxa product is extinguished or completely burned.

Of course, the moxa product may also be used directly without being ignited during the physiotherapy process, but the stage of establishing the connection between the cold and the moxa product takes longer, that is, the first preset time is greater than 30 seconds.

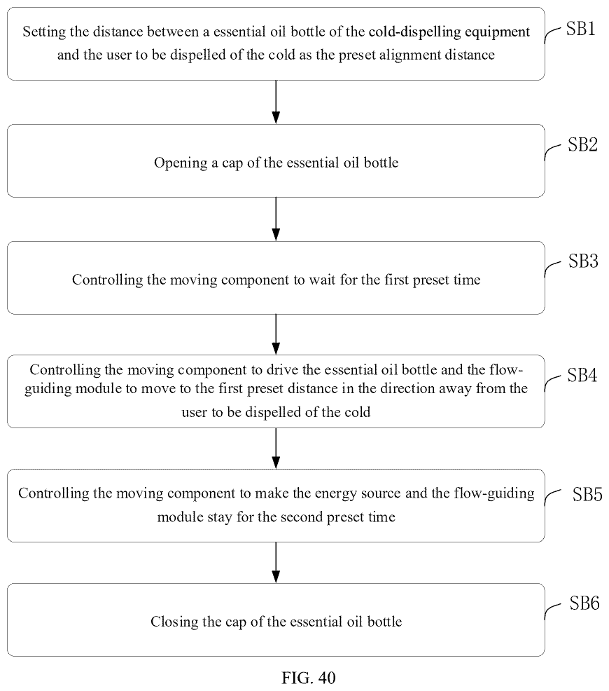

When the energy source is essential oil, as shown in FIG. 40, the using method of the cold-dispelling equipment includes the following steps:
SB1: setting the distance between an essential oil bottle of the cold-dispelling equipment and the user to be dispelled of the cold as the preset alignment distance.
SB2: opening a cap of the essential oil bottle.
SB3: controlling the moving component to wait for the first preset time.
SB4: controlling the moving component to drive the essential oil bottle and the flow-guiding module to move to the first preset distance in the direction away from the user to be dispelled of the cold.
SB5: controlling the moving component to make the energy source and the flow-guiding module stay for the second preset time.
SB6: closing the cap of the essential oil bottle.

The steps SB1 and SB2 may be carried out simultaneously, or either step SB1 or step SB2 may be performed first. In addition, a volatile liquid may be applied to the user (for cold air dispelling) before starting the device. The volatile liquid helps to quickly draw out the cold and assists in establishing the connection between the cold and the essential oil more quickly.

In step SB3, the first preset time is from 15 seconds to 30 seconds.

In step SB4, the moving speed of the essential oil bottle and the flow-guiding module ranges from 2 mm/s to 5 mm/s, and the first preset distance is from 60 cm to 100 cm.

In step SB5, the second preset time does not exceed 1 minute.

Moreover, during the use of the cold-dispelling equipment, it can also be combined with one-key start. One-key start reduces manual operations and improves work efficiency. It can also be combined with a voice prompt to provide prompts when the essential oil bottle and the flow-guiding module reach an initial position and a end position, or issues a reminder during reset. it can also be combined with a counter to facilitate counting and statistics for the operator.

The foregoing content describes the present disclosure in further detail in conjunction with specific optional embodiments, but it should not be construed that the specific implementation of the present disclosure is limited solely to these descriptions. For those of ordinary skill in the art to which the present disclosure pertains, several simple deductions or replacements may be made without departing from the inventive concept of the present disclosure, and these should all be regarded as falling within the protection scope of the present disclosure.

What is claimed is:

1. A curved-surface double-funnel-shaped flow-guiding element, wherein two openings are disposed at two ends of the curved-surface double-funnel-shaped flow-guiding element, and an interior of the curved-surface double-funnel-shaped flow-guiding element is hollow, to form a double-funnel-shaped flow channel; the curved-surface double-funnel-shaped flow-guiding element comprises a first funnel and a second funnel; the first funnel comprises a large-mouth end and a small-mouth end, the second funnel comprises a large-mouth end and a small-mouth end, a diameter of the large-mouth end of the first funnel is greater than a diameter of the small-mouth end of the first funnel, a diameter of the large-mouth end of the second funnel is greater than a diameter of the small-mouth end of the second funnel, and the small-mouth end of the first funnel is in fluid communication with the small-mouth end of the second funnel to form the double-funnel-shaped flow channel;
wherein cross-sectional lines of an inner wall of the first funnel and an inner wall of the second funnel along a central axis of the curved-surface double-funnel-shaped flow-guiding element are curved lines, and the curved lines are concave towards the central axis of the curved-surface double-funnel-shaped flow-guiding element.

2. The curved-surface double-funnel-shaped flow-guiding element according to claim 1, wherein the curved-surface double-funnel-shaped flow-guiding element is a variable-curvature double-funnel-shaped flow-guiding element, the cross-sectional lines of the inner wall of the first funnel and the inner wall of the second funnel along the central axis of the variable-curvature double-funnel-shaped flow-guiding element are the curved lines, and curvatures of the curved lines of the first funnel and the second funnel gradually increase from the large-mouth ends of the first funnel and the second funnel to the small-mouth ends of the first funnel and the second funnel.

3. The curved-surface double-funnel-shaped flow-guiding element according to claim 1, wherein the curved-surface double-funnel-shaped flow-guiding element is the variable-curvature double-funnel-shaped flow-guiding element, the cross-sectional lines of the inner wall of the first funnel and the inner wall of the second funnel along the central axis of the variable-curvature double-funnel-shaped flow-guiding element are the curved lines, and the curvatures of the curved lines of the first funnel and the second funnel first increase to a maximum value and then decrease from the large-mouth ends of the first funnel and the second funnel to the small-mouth ends of the first funnel and the second funnel.

4. The curved-surface double-funnel-shaped flow-guiding element according to claim 1, wherein tangent lines corresponding to endpoints of the curved line of the large-mouth ends of the first funnel are perpendicular or approximately perpendicular to the central axis of the curved-surface double-funnel-shaped flow-guiding element, and tangent lines corresponding to endpoints of the curved line of the large-mouth end of the second funnel are perpendicular or approximately perpendicular to the central axis of the curved-surface double-funnel-shaped flow-guiding element.

5. The curved-surface double-funnel-shaped flow-guiding element according to claim 1, wherein the small-mouth end of the first funnel is in fluid communication with the small-mouth end of the second funnel directly, and a connection between the small-mouth end of the first funnel and the small-mouth end of the second funnel has a smooth transition; and
the first funnel and the second funnel are identical in size and shape, and the first funnel and the second funnel are disposed axisymmetrical to each other.

6. The curved-surface double-funnel-shaped flow-guiding element according to claim 1, wherein the curved-surface double-funnel-shaped flow-guiding element comprises a throat having a hollow interior and two openings disposed at two ends thereof; the two ends of the throat are in fluid communication with the small-mouth end of the first funnel and the small-mouth end of the second funnel respectively; and
a connection between the small-mouth end of the first funnel and the throat has a smooth transition; a connection between the small-mouth end of the second funnel and the throat has a smooth transition.

7. The curved-surface double-funnel-shaped flow-guiding element according to claim 1, wherein an inner wall of the curved-surface double-funnel-shaped flow-guiding element is provided with a plurality of guiding meridians; each of the plurality of the guiding meridians is arranged to extend from the large-mouth end of the first funnel to the large-mouth end of the second funnel;
wherein a distance between each pair of adjacent guiding meridians is equal on a same vertical plane of the central axis of the curved-surface double-funnel-shaped flow-guiding element;
wherein an inner wall of the curved-surface double-funnel-shaped flow-guiding element is further provided with a plurality of guiding latitudes, each of the plurality of the guiding latitudes surrounds the central axis of the curved-surface double-funnel-shaped flow-guiding element, and the plurality of the guiding latitudes are arranged at intervals along the direction of the central axis of the curved-surface double-funnel-shaped flow-guiding element; and
the distance between each pair of adjacent guiding latitudes gradually increases along an extending direction from a center of the curved-surface double-funnel-shaped flow-guiding element to the two ends thereof.

8. A series-linear flow-guiding assembly, wherein two openings are disposed at two ends of the series-linear flow-guiding assembly, and an interior of the series-linear flow-guiding assembly is hollow, to form a flow channel; the series-linear flow-guiding assembly comprises at least two curved-surface double-funnel-shaped flow-guiding elements as claimed in claim 1 being arranged in sequential orientation;
wherein the large-mouth ends of each pair of adjacent curved-surface double-funnel-shaped flow-guiding elements in the series-linear flow-guiding assembly are disposed opposite to each other; and projections of the large-mouth ends of each pair of adjacent curved-surface double-funnel-shaped flow-guiding elements at least partially overlap in an axial direction of the curved-surface double-funnel-shaped flow-guiding elements.

9. The series-linear flow-guiding assembly according to claim 8, wherein in the series-linear flow-guiding assembly, projections of through-holes at centers of all the curved-surface double-funnel-shaped flow-guiding elements in the series-linear flow-guiding assembly at least partially overlap in the axial direction of the curved-surface double-funnel-shaped flow-guiding element.

10. The series-linear flow-guiding assembly according to claim 8, wherein the series-linear flow-guiding assembly at least comprises a first curved-surface double-funnel-shaped flow-guiding element, a second curved-surface double-funnel-shaped flow-guiding element, and a third curved-surface double-funnel-shaped flow-guiding element; and the second curved-surface double-funnel-shaped flow-guiding element is disposed between the first curved-surface double-funnel-shaped flow-guiding element and the third curved-surface double-funnel-shaped flow-guiding element;
wherein a size of the first curved-surface double-funnel-shaped flow-guiding element and a size of the third curved-surface double-funnel-shaped flow-guiding element are both larger than a size of the second curved-surface double-funnel-shaped flow-guiding element.

11. The series-linear flow-guiding assembly according to claim 8, wherein there are at least three curved-surface double-funnel-shaped flow-guiding elements having a same shape but different sizes; the diameters of the large-mouth ends of the curved-surface double-funnel-shaped flow-guiding elements increase or decrease one by one along the direction of the central axis of the curved-surface double-funnel-shaped flow-guiding element.

12. A nested flow-guiding assembly, wherein two openings are disposed at two ends of the nested flow-guiding assembly, and an interior of the nested flow-guiding assembly is hollow, to form a flow channel; the nested flow-guiding assembly comprises at least two levels of the curved-surface double-funnel-shaped flow-guiding elements as claimed in claim 1, sizes of the curved-surface double-funnel-shaped flow-guiding elements at different levels are different, and
the curved-surface double-funnel-shaped flow-guiding element at a lower level is nested within the curved-surface double-funnel-shaped flow-guiding element at a upper level; and
projections of the through-holes at a narrowest portion of the flow channels of the curved-surface double-funnel-shaped flow-guiding element at the upper level and the curved-surface double-funnel-shaped flow-guiding element at the lower level in the nested flow-guiding assembly at least partially overlap in the axial direction of the curved-surface double-funnel-shaped flow-guiding element at the upper level.

13. The nested flow-guiding assembly according to claim 12, wherein the central axes of curved-surface double-funnel-shaped flow-guiding elements in the nested flow-guiding assembly are aligned on the same straight line.

14. The nested flow-guiding assembly according to claim 12, wherein an air passage is formed between each pair of two-level curved-surface double-funnel-shaped flow-guiding elements in the nested flow-guiding assembly; two ends of the air passage are respectively in communication with the external environment at two ends of the nested flow-guiding assembly.

15. The nested flow-guiding assembly according to claim 12, wherein the number of the curved-surface double-funnel-shaped flow-guiding element at each level is only one, and center points of all the curved-surface double-funnel-shaped flow-guiding elements at different levels coincide.

16. The nested flow-guiding assembly according to claim 12, wherein the nested flow-guiding assembly is a three-level nested flow-guiding assembly; the nested flow-guiding assembly is composed of a first-level curved-surface double-funnel-shaped flow-guiding element, a second-level curved-surface double-funnel-shaped flow-guiding element, and a third-level curved-surface double-funnel-shaped flow-guiding element; the third-level curved-surface double-funnel-shaped flow-guiding element is nested within the second-level curved-surface double-funnel-shaped flow-guiding element, and the second-level curved-surface double-funnel-shaped flow-guiding element is nested within the first-level curved-surface double-funnel-shaped flow-guiding element.

17. The nested flow-guiding assembly according to claim 12, wherein the number of the curved-surface double-funnel-shaped flow-guiding elements at the lower level is at least two, and at least two curved-surface double-funnel-shaped flow-guiding elements at the lower level are arranged side-by-side and nested within the curved-surface double-funnel-shaped flow-guiding element at the upper level, and the large-mouth ends of each pair of the curved-surface double-funnel-shaped flow-guiding elements at the same level are arranged opposite to each other.

18. The nested flow-guiding assembly according to claim 12, wherein the nested flow-guiding assembly comprises the first-level curved-surface double-funnel-shaped flow-guiding element, the second-level curved-surface double-funnel-shaped flow-guiding element, and the third-level curved-surface double-funnel-shaped flow-guiding element; the number of the first-level curved-surface double-funnel-shaped flow-guiding element is one, the number of the second-level curved-surface double-funnel-shaped flow-guiding elements is two, and the number of the third-level curved-surface double-funnel-shaped flow-guiding elements is four;
wherein each pair of the third-level curved-surface double-funnel-shaped flow-guiding elements is arranged side-by-side and nested within a corresponding second-level curved-surface double-funnel-shaped flow-guiding element, and large mouth ends of the each pair of the third-level curved-surface double-funnel-shaped flow-guiding elements are disposed opposite to each other; each pair of the second-level curved-surface double-funnel-shaped flow-guiding elements are arranged side-by-side and nested within the first-level curved-surface double-funnel-shaped flow-guiding element, and large mouth ends of each pair of the second-level curved-surface double-funnel-shaped flow-guiding elements are disposed opposite to each other.

19. The nested flow-guiding assembly according to claim 12, wherein the curved-surface double-funnel-shaped flow-guiding element at the lower level is an equal-proportion scaled-down version of the curved-surface double-funnel-shaped flow-guiding element at the upper level.

20. The nested flow-guiding assembly according to claim 12, wherein a distance, measured along the central axis, between the large-mouth end of the curved-surface double-funnel-shaped flow-guiding element at the lower level and the large-mouth end of the curved-surface double-funnel-shaped flow-guiding element at the upper level exceeds one-fourth of an axial length of the curved-surface double-funnel-shaped flow-guiding element at the upper level.
